(19) United States
(12) Patent Application Publication
(10) Pub. No.: US 2008/0249950 A1
(43) Pub. Date: Oct. 9, 2008

(54) Method and apparatus for conducting transactions generated at point-of-sale locations

(76) Inventors: Thami Smires, Parlin, NJ (US); Paul Sabella, Columbia, MD (US); Glen Dentice, Pasadena, MD (US)

Correspondence Address: HOFFMAN, WASSON & GITLER, P.C., Suite 522, 2461 South Clark Street, Arlington, VA, 22202, US

(21) Appl. No.: 12/155,480

(22) Filed: Jun. 5, 2008

Related U.S. Application Data
(63) Continuation of application No. 10/658,405, filed on Sep. 10, 2003.
(60) Provisional application No. 60/409,226, filed on Sep. 10, 2002.

(51) Int. Cl. G06Q 20/00; H04L 9/32; G06Q 10/00

(52) U.S. Cl. 705/75; 705/39; 705/30

(57) ABSTRACT

A system and method for conducting credit card or debit card transactions in a wired or wireless network. A merchant utilizing one of a number of terminals would input information through one of a particular number of gateways to a central credit card processing center. The credit card processing center would review each transaction and process the transaction and then send a conformation or disapproval of the transaction to the appropriate merchant, as well as transmitting the transaction to one of a plurality of credit card or debit card processors. In this manner, a terminal provider would not be forced to certify the terminal with each of the credit card processors, but would only have to certify to the system itself. Additionally, the system includes a website allowing each merchant to review and alter any one of a number of transactions.

The application is based upon Provisional Application Ser. No. 60/409,226, filed Sep. 10, 2002 and is a continuation of U.S. patent application Ser. No. 10/658,405, filed Sep. 10, 2003.

### BACKGROUND OF THE INVENTION

The use of credit and debit cards has become ubiquitous in our current commercial transaction society. Virtually, every merchant, as well as other facilities where monetary transactions occur for the purchase of goods or services, such as medical offices, schools and universities, accept credit and debit cards for these transactions. Once a credit card or debit card is presented to a particular merchant or facility to purchase goods or services, the credit or debit card is usually inserted into a terminal such as a card swipe having a keyboard associated therewith. The information provided generally on a magnetic strip on the rear side of the credit or debit card is transmitted to a central location along with information relating to purchase price, as well as the particular merchant. The central location is provided with a database used to approve or disapprove the transaction. Generally, reasons for disapproval of a transaction might include non-payment of the balance of the credit card, the purchase price would exceed the limit assigned to a particular credit card account or there is insufficient money in the customer's account to allow the customer to utilize the debit card. Once a decision is made at the central location, a return message is sent to the merchant indicating the disposition of the transaction.

Prior art systems generally would connect the merchant with the central location for obtaining approval of the transaction with a telephone line. As can be appreciated, this type of connection is relatively slow. Additionally, the terminal located at the merchant's establishment would generally be provided with a screen in which only limited information would be displayed thereon. Furthermore, there was essentially no further interaction between the merchant and the central location after the credit card or debit card was swiped at the terminal and the merchant provided additional information relating to the transaction.

Presently, there exist a number of credit card processors for dealing with commercial transactions, as well as a number of manufacturers of terminal devices used to swipe credit and debit cards. Prior art systems would require that each of the manufacturers must certify each type of terminal with each of the credit card processors.

### SUMMARY OF THE INVENTION

The deficiencies of the prior art are addressed by the method and system of the present invention allowing point-of-sale terminals to communicate with a single system entity for the purpose of quickly and easily conducting commercial transactions utilizing a credit card or debit card. This system would utilize a wired or wireless communication network between each merchant or sub-merchants, such as delivery trucks, with a single processing center for the approval or disapproval of each transaction. This system would also allow each of the merchants to utilize a website to view their transactions, as well as changing the transactions, if required.

Various gateways are provided to receive the information from the point-of-sale merchant terminals. These gateways are connected to the merchant's terminals utilizing either a wired or wireless communication network. The gateways serve as entry points from different communication networks and perform protocol conversion from the native network protocols to the proprietary protocol used at both transport and data layers as necessary. Each of the gateways is provided in a wired or wireless system to a credit card server center for receiving, completing and recording the transactions from the gateways. The number of credit card processors capable of using this system would be limitless. Therefore, the present system would allow for each terminal manufacturer to certify with the system of the present invention and not with each of the credit card processors, each type of terminal they manufacture.

The credit card service center would have a database associated therewith and allowing the credit card service center to process and record each of the transactions. Once a transaction is approved or disapproved, this information would be transmitted to the particular gateway utilized and then to the particular point-of-sale terminal which initiated the transaction.

A website is included in the present system allowing merchants to review their transaction in real time, void transactions and to perform additional services. A credit card server ISAPI is provided between a transaction manager and the credit card server and is used as an interface therebetween creating sockets as required between the web application and the credit card server.

The present invention and its advantages, those described above and otherwise, will be appreciated from studying the following detailed description and drawing.

### BRIEF DESCRIPTION OF THE INVENTION

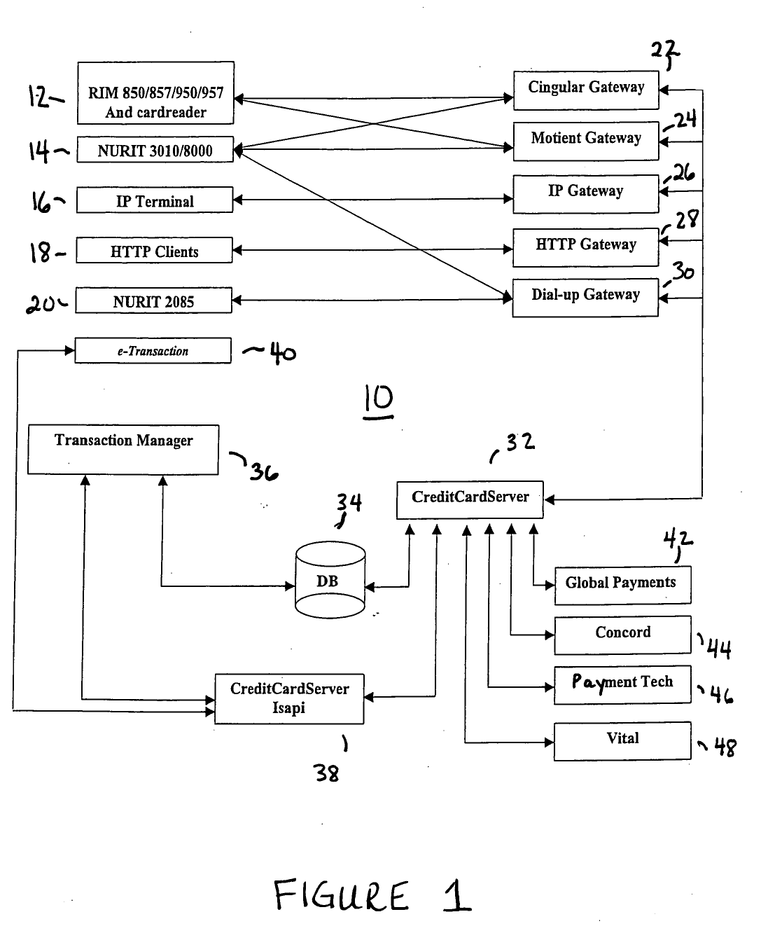

FIG. 1 is a block diagram showing the major components of the system of the present invention.

### DETAILED DESCRIPTION OF THE PREFERRED EMBODIMENTS

The present invention would allow for the processing of credit and debit cards. The processing of the credit card and debit card transactions would benefit from the variety of processors supported and automatically take advantage of any new processors that are certified by the system of the present invention. Additionally, since the system supports a variety of transport platforms, applications and application developers are not limited to utilizing any specific protocol in the development of their particular transport platform.

As shown in FIG. 1, the system 10 employs various devices located at the point of sale for initiating the transaction. Each of these devices would include a card swipe, as well as the appropriate keyboard and display for reading the information provided on the magnetic strip attached to each credit card or debit card, as well as allowing the merchant to enter other relevant information relating to the transaction. The display would indicate whether the transaction has been approved or disapproved by the central system and would also include a code associated therewith. For example, device 12 would utilize a research in motion (RIM) device denoted as RIM 850/857 or RIM 950/957, which would wirelessly transmit information from the merchant's terminal to one of two gateways operated by the present invention. The RIM 850/857 terminal would run on a datatac network denoted as the motient gateway 24. The RIM 950/957 terminal would run on a mobitex network which is designated as the cingular gateway 22. Both of these networks are pure data networks and provide speeds of up to 9600 bps for the mobitex system and 19200 bps for the datatac system. These data networks are built to support bursts of small amounts of data in short periods of time and thus are adequate for the credit card processing business. Other wireless devices, such as the Nurit 3010 or the Nurit 8000 could operate both as a wireless transmission system, as well as a dial-up transmission system to process the credit card transactions. As shown in FIG. 1, the Nurit 3010/8000 devices 14 are bilaterally connected to either the cingular gateway network 22 or the motient gateway network 24. Additionally, the Nurit 3010/8000 devices could each be connected to a dial-up gateway 30. Both the Nurit 3010 and Nurit 8000 were developed by Lipman.

Lipman has also developed the Nurit 2085 20 device which is only connected to the dial-up gateway 30. Other types of terminals, such as an IP terminal 16 and an HTTP terminal 18 could also be utilized. The IP terminal is directly connected to an IP gateway 26 and the HTTP terminal 18 would be connected to an HTTP gateway 28. The IP gateway is socket-based and receives IP-based transactions from IP-based devices. The HTTP gateway receives HTTPs-based transactions from point-of-sales devices that choose to use HTTPs.

All of the gateways 22, 24, 26, 28 and 30 do not encrypt, decrypt or analyze the data transmitted from the various terminals 12, 14, 16, 18 and 20. As shown in FIG. 1, all of the connections between the various terminals 12, 14, 16, 18 and 20 and the various gateways 22, 24, 26, 28 and 30 are bilateral in nature. The sole purpose of each of the gateways 22, 24, 26, 28 and 30 would be to serve as entry points from the various communication networks and to perform protocol conversion from the native network protocols to the proprietary protocol of the system forming the present invention.

Once data is received from any of the gateways 22, 24, 26, 28 and 30, it is immediately transmitted to a credit card server 32. Although the gateways 22, 24, 26, 28 and 30 do not encrypt information, this information might be encrypted from any one of the terminals 12, 14, 16, 18 and 20. If this is the case, the credit card server 32 would initially decrypt this information. Once this is accomplished, the credit card server would verify the data's integrity using transaction elements parsed out based upon rules established by the system of the present invention. The merchant/POS is identified and verified to insure that that particular merchant/POS is allowed to perform monetary transactions. If it is determined that the merchant/POS is not allowed to do such a transaction, the transaction request is denied and a message is transmitted through the appropriate gateway to the appropriate terminal.

The credit card server 32 is bilaterally connected to a master database 34. This master database contains information such as a merchant/POS identification number, as well as a bank identification number that correspond to the device identification number extracted from the database 34. Additionally, some of the data received from the credit card server 32 would be checked against the master database. This information would include, but is not limited to, the type of transaction and a unique transaction identification number to further validate the commercial transaction. The credit card server 32 would encrypt the credit card or debit card number, as well as any additional tracked data using a different encryption algorithm that was used to encrypt the information sent from the various terminals 12, 14, 16, 18 and 20. The purpose of this encryption would be to solely make the data unreadable before it is entered into the database 34. The transaction data, which is now entered into the database 34, would be for the purpose of billing, viewing by a particular merchant, as well as reporting each transaction.

The present invention is designed to be utilized with a number of credit card processors. These credit card processors are bilaterally connected to the credit card server 32 and would include, but would not be limited to, the Global Payment processor 42, the Concord processor 44, the Payment Tech processor 46 and the Vital processor 48. As can be appreciated, once more processors are developed, they would also be utilized by the system of the present invention. The credit card server 32 would be provided with a decision table to determine which would be the appropriate processor to send the particular commercial transaction. Based upon the particular destination processor, the credit card server 32 would format the data perfectly. For example, the Global Payment processor 42 would be sent data via a dedicated line via a socket. If the Concord processor would be utilized, data would be sent using HTTPs protocol. Once this data is sent to the appropriate processor 42, 44, 46 or 48, a message would be generated by the particular processor and then retransmitted to the card server 32. This transmission would then be interpreted and a proper response would be sent to the particular terminal 12, 14, 16, 18 and 20 which initiated the transaction through the appropriate gateway 22, 24, 26, 28 and 30. This information could also be entered into the database 34.

A credit card server ISAPI 38 is provided as an interface between a transaction manager 36 and the credit card server 32. This gateway creates sockets as required between the web application of the present invention and the appropriate credit card server.

The transaction manager 36 would allow merchants to view their transactions during real time, generate reports, manage users and their point-of-sale devices by a website operated by the transaction manager 36. The utilization of the credit card server ISAPI 38 would allow certain interactions with the server, such as wireless updates to certain features of the wireless credit card processing application. Each particular merchant would be assigned a unique user name and password allowing the merchant to view and alter various transactions. This would be of great benefit if the merchant in the course of its business employs a plurality of remote or mobile units. Therefore, if a mobile unit would initiate a transaction subsequently cancelled by a customer, the merchant, utilizing the website would be able to cancel the commercial transaction much more quickly than by other prior art systems.

The present invention also contemplates the use of web purchases without the necessity of the terminals 12, 14, 16, 18 and 20. This e-charge portion 40 is connected to the credit card server ISAPI 38 which is in turn connected to the credit card server 32 for the processing of the transaction through any one of the processors 42, 44, 46 and 48. Approval of the transaction would then be sent from the credit card server 32 to the credit card ISAPI 38 and then back to the e-charge 40. The system would then accommodate an Internet-based virtual POS that uses IP and SSL to process transactions.

Since each of the processors would be certified by the system of the present invention, it would not be necessary for each of the terminal providers to obtain certification from each of the processors. The present invention would then eliminate the need for each terminal provider from obtaining the appropriate certification. Each of the terminal providers would only be required to obtain certification from the system of the present invention. The system of the present invention would obtain certification from each and every credit card processor.

While the present invention has been described with reference to one or more particular embodiments, those skilled in the art will recognize that many changes may be made thereto without departing from the spirit and scope of the present invention. Each of these embodiments in obvious variations thereof, will be contemplated as falling within the spirit and scope of the claimed invention, which is set forth in the following claims.

What is claimed is:

1. A system for controlling the processing of credit card and debit card transactions, between various types of point-of-sale terminal devices initiating the transactions transmitted ultimately to a plurality of credit card processors through a plurality of gateway networks, comprising:
a credit card server in communication with the plurality of gateways and the credit card processors, said credit card server receiving a credit card or debit card transaction request from the point-of-sale terminal devices through the plurality of gateway networks, said credit card server processing the transaction and sending the transaction to any of the credit processors, said credit card server communicating with the terminal devices indicating the disposition of each of the transactions;
a database connected to said credit card server for maintaining and reading information relating to the transactions and the point-of-sale terminal devices; and
a transaction manager connected to said credit card server for managing a website allowing the merchant associated with each of the point-of-sale terminal devices to view their respective transactions as well as altering the transactions.

2. The system in accordance with claim 1, wherein a display is associated with the point-of-sale terminal devices, allowing the merchant to view their respective transactions.

3. The system in accordance with claim 2, wherein the respective transactions are viewed in real time.

4. The system in accordance with claim 1, wherein at least one of the point-of-sale terminal devices encrypt information transmitted over said gateway networks.

5. The system in accordance with claim 4, wherein said encrypted information is decrypted by said credit card server.

6. The system in accordance with claim 1, wherein information included in the transaction is authenticated by said credit card server.

7. The system in accordance with claim 6, wherein said credit card server denies a transaction if said information included in the transaction is incorrect, based upon date provided in said database.

8. The system in accordance with claim 1, wherein said credit card server would encrypt at least a portion of the information included in the transactions prior to entering this information in said database.

9. The system in accordance with claim 1, further including a plurality of credit card processors in connection with said credit card server.

10. The system in accordance with claim 9, wherein said credit card server is provided with a decision table used to decide which of said plurality of credit card processors would receive a particular transaction.
